(19) United States
(12) Patent Application Publication
(10) Pub. No.: US 2026/0089176 A1
(43) Pub. Date: Mar. 26, 2026

(54) PREDICTING SECURITY THREATS USING ENRICHED DATA AND A THREAT ANALYSIS MODEL

(71) Applicant: MASTERCARD INTERNATIONAL INCORPORATED, PURCHASE, NY (US)

(72) Inventors: Aaron John GOMEZ, Cottleville, MO (US); Paul C. MATTHEWS, O'Fallon, MO (US)

(21) Appl. No.: 19/334,733

(22) Filed: Sep. 19, 2025

Related U.S. Application Data
(60) Provisional application No. 63/697,426, filed on Sep. 20, 2024.

(51) Int. Cl. H04L 9/40; H04L 9/08

(52) U.S. Cl. CPC H04L 63/1416; H04L 9/0825

(57) ABSTRACT

A computerized method predicts security threats using comprehensive datasets. The method includes obtaining private data from at least one private data source and public data from at least one public data source. The private data and public data are transformed into enriched data that associates related data portions to form comprehensive records of entities or events. Sensitive portions of the private data are analyzed to determine statistical patterns, and synthetic data is generated that reflects the patterns without revealing sensitive details. The enriched data and synthetic data are provided as input to a threat analysis model trained to generate threat analysis output data, including threatscape analysis data, potential security trend data, and anticipated resiliency trend data. Based on the generated output data, one or more security threat prevention actions are performed, such as generating and implementing multi-year threat plans, adjusting system security configurations, or prioritizing mitigation actions.

### CROSS-REFERENCE TO RELATED APPLICATION

This application claims the benefit of, and priority to, Provisional Patent Application No. 63/697,426, filed September 20^{th}, 2024. The entirety of the disclosure of the application is incorporated herein by reference.

### BACKGROUND

Organizations employ various security monitoring tools to detect and respond to threats. Conventional threat prediction techniques often suffer from incomplete or siloed data sources, which limit the scope and accuracy of predictions. Public data may lack the detail needed for robust analysis, while private data sources often contain sensitive information that cannot be directly shared or processed due to privacy regulations and contractual restrictions. As a result, threat prediction models trained on limited datasets can produce inaccurate forecasts, particularly for long-term or emerging threats. There exists a need for a system that accurately generates forecasts and identifies threats based on complete information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for analyzing datasets to predict threats is described. The computerized method for predicting security threats uses enriched and synthetic data in a threat analysis model. The method includes obtaining private data from one or more private data sources and public data from one or more public data sources. The private and public data are transformed into enriched data by identifying related portions of data and combining them to produce comprehensive records of entities or events. Sensitive data within the private data is analyzed to determine statistical patterns, and synthetic data is generated that retains those patterns while removing or replacing sensitive details. The enriched data and synthetic data are provided as input to a threat analysis model configured to generate threat analysis output data, such as long-term threat forecasts, predicted security trends, and anticipated resiliency patterns.

### BRIEF DESCRIPTION OF THE DRAWINGS

The present description will be better understood from the following detailed description read considering the accompanying drawings, wherein:

FIG. 1 is a block diagram illustrating a system configured for generating threat analysis data by analyzing private data from private data sources and public data from public data sources;

FIG. 2 is a flowchart illustrating a method of generating threat analysis output data based on a combination of private data and public data and performing a security threat prevention action based on the threat analysis output data;

FIG. 3 is a flowchart illustrating a method of training a threat analysis model;

FIG. 4 is a diagram illustrating a threatscape graphical user interface (GUI) configured to display and/or enable interaction with threat analysis output data; and

FIG. 5 illustrates an example computing apparatus as a functional block diagram.

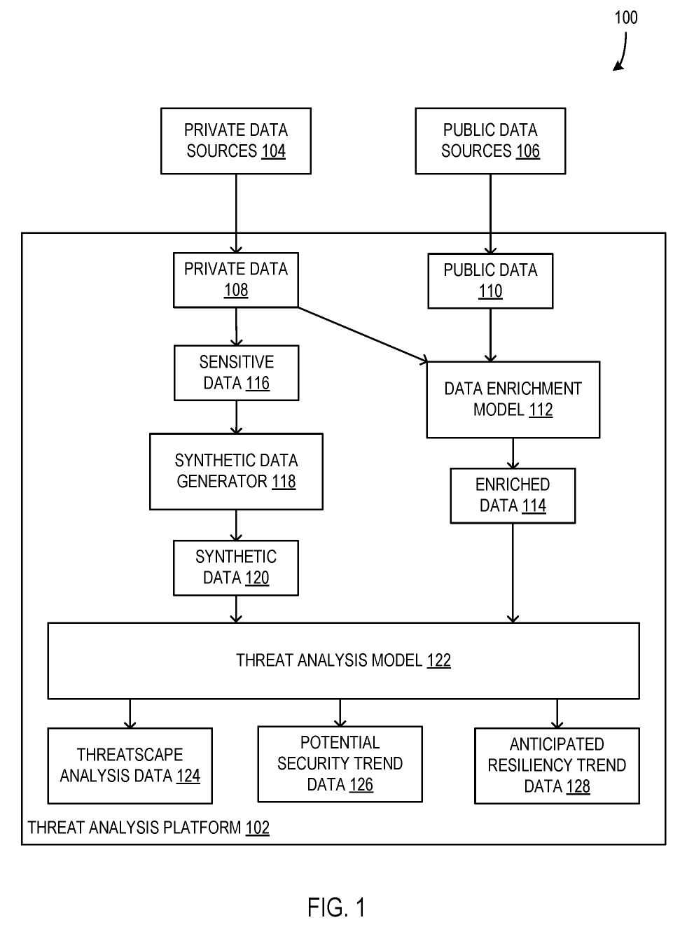

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for obtaining data from private and public sources, enriching the obtained data, and providing the enriched data as input to a threat analysis model. The threat analysis model is trained to generate threat analysis output data such as threatscape analysis data, potential security trend data, and anticipated resiliency trend data. The output data of the threat analysis model is used to perform security threat prevention actions, such as setting plans in place to address predicted threats when they occur, changing security rules, settings, and behaviors to prevent threats from occurring, or the like.

The disclosure operates in an unconventional manner at least by using private data from private data sources in combination with public data from public data sources. The disclosure enables access to private data, such as transaction data, data associated with security events, or the like. This private data is analyzed and combined with accessible public data to form enriched data artifacts that contain comprehensive data records associated with specific entities and/or events. The use of the combined, enriched data sets provides increased quantities of relevant data values for predicting security threats and events, and thus improves the accuracy and efficiency of the threat analysis model. Further, because of the use of the improved data sets as described herein, the time and processing resources required to train the threat analysis model are reduced compared to existing systems. Thus, the model training process described herein is technically improved with respect to processing resource usage and other related resource usage.

Further, the disclosure enables the use of valuable data patterns in sensitive data of the private data by analyzing the sensitive data and generating synthetic data based on that analysis. Private data often includes data that is sensitive for various reasons and data privacy policies prevent exposure of such sensitive data during analysis. However, the valuable data patterns in the sensitive data can be used without exposure of the sensitive details thereof. The disclosure determines statistical patterns in the sensitive data and then generates synthetic data that also reflects those statistical patterns, such that the threat analysis model can be trained on and use those statistical data patterns without accessing the sensitive details of the private data. Thus, generating and using synthetic data as input to the threat analysis model provides the threat analysis model with more comprehensive data and thereby improves the efficiency and resource costs of training the model and improves the accuracy of the trained model. Further, examples of the disclosure do not expose the sensitive details in the private data providing enhanced data security to the sensitive details in the private data. At the same time, by using synthetic data having the statistical data patterns of the private data, aspects of the disclosure provide a comprehensive threat analysis without actually using the sensitive details in the private data.

FIG. 1 is a block diagram illustrating a system 100 configured for generating threat analysis data (e.g., threatscape analysis data 124, potential security trend data 126, and/or anticipated resiliency trend data 128) by analyzing private data 108 from private data sources 104 and public data 110 from public data sources 106. In some examples, the threat analysis platform 102 analyzes the private data 108 and public data 110 using a data enrichment model 112 to generate enriched data 114, which is then provided to the threat analysis model 122 as input. Further, in some examples, the threat analysis platform 102 identifies or otherwise determines sensitive data 116 that is present in the private data 108 and uses the synthetic data generator 118 to generate synthetic data 120 based on that sensitive data 116, such that sensitive elements of the sensitive data 116 are not exposed or revealed to the threat analysis model 122. The threat analysis model 122 uses the enriched data 114, the synthetic data 120, and/or other aspects of the private data 108 and/or public data 110 to generate threat analysis data such as the threatscape analysis data 124, the potential security trend data 126, and/or the anticipated resiliency trend data 128, as described herein.

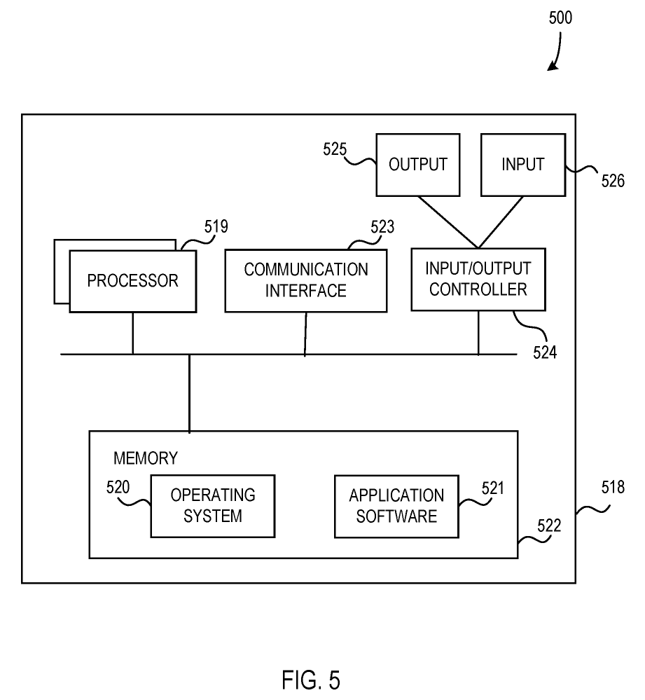

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, the system 100 is configured to be stored and/or executed on a single computing device. Alternatively, in some examples, entities of the system 100 are configured to be distributed between the multiple computing devices and to communicate with each other via network connections. For example, the data enrichment model 112 is executed on a first computing device and the threat analysis model 122 is located on a second computing device within the system 100. The first computing device and second computing device are configured to communicate with each other via network connections. Alternatively, in some examples, other components of the threat analysis platform 102 (e.g., interfaces for obtaining data from the data sources 104-106, the synthetic data generator 118, and/or data stores for the generated threat analysis data) are executed on separate computing devices and those separate computing devices are configured to communicate with each other via network connections during the operation of the threat analysis platform 102. In other examples, other organizations of computing devices are used to implement system 100 without departing from the description.

In certain implementations, the system executes enrichment and synthetic data generation on specialized hardware components distinct from the threat analysis model execution environment. For example, the data enrichment model 112 may be deployed on a first processing module optimized for high-throughput data joins and lookups (e.g., FPGA-accelerated query processors), while the threat analysis model 122 is hosted on a GPU-based inference server. This separation of concerns reduces contention for processing resources, enabling both stages to execute in parallel without performance bottlenecks. Firmware-level scheduling on the enrichment module prioritizes only those records that contribute to enriched artifacts meeting predefined confidence thresholds, further reducing unnecessary load on the inference hardware.

The threat analysis platform 102 includes hardware, firmware, and/or software configured to receive or otherwise obtain private data 108 and/or public data 110 from the private data sources 104 and/or public data sources 106, analyze the obtained data, and generate threat analysis data 124-128 as described herein. In some examples, the threat analysis platform 102 is configured to periodically request or receive data from the data sources 104-106. Alternatively, or additionally, in some examples, the threat analysis platform 102 is configured to request or receive data from the data sources 104-106 in response to the occurrence of events. For instance, in an example, a private data source 104 is updated to include new private data 108 and the private data source 104 notifies the threat analysis platform 102 that new data is available. The threat analysis platform 102 then requests the new data in response to the notification received from the private data source 104. In other examples, other methods of obtaining data from the data sources 104-106 are used without departing from the description.

In some examples, the private data sources 104 are configured to store private data 108 associated with events (e.g., payments or transactions) and/or entities (e.g., merchants, customers, or the like) that is not shared with the public due to its sensitivity and/or other factors (e.g., a private data source 104 is controlled by an entity with which a customer has an agreement requiring the entity to keep the private data 108 private). In some such examples, the private data 108 stored in the private data sources 104 include firewall logs associated with an entity and/or other Internet Protocol (IP) address-based data, customer data, transaction data, account data, event data associated with events during which data or account access was compromised, data associated with merchant transactions and/or events associated with merchant transactions, or the like.

Further, in some examples, the public data sources 106 are configured to store public data 110 associated with events and/or entities that is available to at least some portion of the public. In some such examples, the public data 110 includes publicly available identity information of users and/or entities, data posted by users such as social media data, or the like.

The data enrichment model 112 includes hardware, firmware, and/or software configured to generate enriched data 114 using private data 108 and public data 110. In some examples, the generation of the enriched data 114 includes combining portions of the private data 108 with portions of the public data 110 based on the private data portions being associated with the same entity or event as the public data portions. As a result of the enrichment, the enriched data 114 includes a comprehensive data set associated with the event or entity that can be used by the threat analysis model 122 as described herein. For instance, in an example, the private data 108 includes access event data from a firewall log that includes an IP address and the public data 110 includes data that associates the IP address with a user’s name and/or other identifying information. The data enrichment model 112 determines that the access event data and the user identifying information are associated with the same entity and combines those data into an enriched data 114 that is associated with the entity. Thus, the enriched data 114 includes an entry that indicates that the user identified by the identifying information may have tried to gain access through the firewall or security system on the date and time indicated in the access event data. It should be understood that, in other examples, other relationships between private data and public data are identified by the data enrichment model 112 and used by the data enrichment model 112 to generate enriched data 114 without departing from the description.

In some examples, the data enrichment model 112 is a trained machine learning (ML) or artificial intelligence (AI) model. In some such examples, the data enrichment model 112 is trained using ML techniques to identify likely relationships between portions of the private data 108 and portions of the public data 110. For instance, the data enrichment model 112 is provided a set of public data 110 and an individual entry of private data 108. The data enrichment model 112 performs data analysis per its training and generates scores for each entry of the set of public data 110 that indicate a likelihood that that entry of public data 110 is associated with the individual entry of private data 108. Such analysis can be performed for each private data entry, such that likely relationships between the private data entries and public data entries are determined. A pair of data entries that are sufficiently likely to be related (e.g., a score generated by the model 112 exceeds a defined threshold) are combined into enriched data entries by the data enrichment model 112. In other examples, other ML methods of identifying relationships between private and public data entries are used by the data enrichment model 112 without departing from the description.

Additionally, or alternatively, in some examples, the data enrichment model 112 is trained using ML principles or techniques. In some such examples, a set of training data includes data from at least a portion of private data sources 104 and data from at least a portion of the public data sources 106 and, for the data in the training data set, the relationships between private data and public data are known. The data enrichment model 112 is initialized to generate scores that indicate the likelihood that two data entries are related. Portions of the training data set are provided as input to the data enrichment model 112 and the data enrichment model 112 generates scores for pairs of data entries in those input data. The generated scores are compared to the known relationships between the private data and public data of the training data set. An accuracy of the generated scores is determined based on scores for pairs of data entries indicating a high likelihood of association for pairs that are known to be related. Scores that indicate high likelihood of association for pairs that are not related and/or scores that indicate a low likelihood of association for pairs that are related are also used in determining an accuracy of the data enrichment model 112. Based on the determined accuracy values, parameters, weights, and/or other elements of the data enrichment model 112 are adjusted according to ML techniques, such that the accuracy of the data enrichment model 112 is improved for the purpose of generating scores for input data that is similar to the training data. In other examples, other methods of training the data enrichment model 112 are used without departing from the description.

For instance, in some embodiments, the data enrichment model 112 is trained using unsupervised ML leveraging algorithms such as soft clustering, association, and/or topic modeling. Soft clustering (e.g., fuzzy c-means, Gaussian mixture models, or hierarchical soft clustering) allows relationships to be built across overlapping groups of data entries to measure connectivity based on distance or similarity metrics when organizing collections of items. Association rule learning enables the discovery of correlations between parameters of large datasets (e.g., detecting co-occurrence of network anomalies with geographic indicators), and topic modeling (e.g., latent Dirichlet allocation) enables the extraction of hidden patterns and structures from large bodies of unstructured text, such as news reports or social media posts, to reveal trends, public sentiment, emerging issues, or discussion topics across disparate sources. These unsupervised techniques increase the completeness and contextual richness of the enriched data 114, enabling the threat analysis model 122 to more accurately generate threatscape analysis data 124, potential security trend data 126, and resiliency trend data 128. In some examples, the clustering or association outputs are also used to characterize statistical distributions that inform the generation of synthetic data 120 by the synthetic data generator 118. Additionally, or alternatively, semisupervised or reinforcement learning techniques are employed when labeled threat indicators are available, thereby further refining the ability of the data enrichment model 112 to identify relationships between private and public data entries.

The synthetic data generator 118 includes hardware, firmware, and/or software configured to analyze statistical patterns of the sensitive data 116 and, based on that analysis, to generate synthetic data 120 that mirrors those statistical patterns without revealing any sensitive details of the sensitive data 116. In some examples, the private data 108 includes sensitive transaction data 116 that is sensitive due to the transaction data including personally identifiable information (PII). The sensitive data 116 is provided to the synthetic data generator 118 and the synthetic data generator 118 identifies one or more statistical patterns in the sensitive data 116. In some examples, the statistical patterns include quantities of transactions, timing of transactions, patterns of transactions between two or more different parties or entities, patterns in transaction amounts, patterns in IP addresses or other similar identifying information associated with electronic transactions, or the like.

Further, in some examples, the synthetic data generator 118 uses the identified statistical patterns to generate synthetic data 120. In such examples, the synthetic data 120 includes sets of data entries that match or mirror the identified statistical patterns in the sensitive data 116 while many data values, such as the PII data of the sensitive data 116, have been replaced with data values that are randomly generated or otherwise not associated with real transactions, entities, or events.

It should be understood that, unlike traditional ETL pipelines that merely extract, transform, and load disparate datasets into a common schema, the enrichment process described herein performs semantic correlation between private and public data at a per-entity or per-event level using trained relationship models. This process does not simply normalize or cleanse data but actively generates new composite records that contain predictive relationships absent from either source dataset alone. The synthetic data generation stage further departs from ETL by incorporating statistical pattern extraction and pattern-preserving randomization to produce training-ready datasets without sensitive identifiers. This dual-stage process yields input data that is richer in predictive signal and less burdened by irrelevant noise than data produced by conventional ETL workflows.

The threat analysis model 122 includes hardware, firmware, and/or software configured to generate threat analysis data such as threatscape analysis data 124, potential security trend data 126, and/or anticipated resiliency trend data 128 using enriched data 114, synthetic data 120, and or other data associated with the private data 108 and/or the public data 110. In some examples, the generation of the threat analysis data includes providing the enriched data 114 and/or the synthetic data 120 as input to the threat analysis model 122 and the threat analysis model 122 performing analysis operations on the input data. As a result of the analysis, the threat analysis data is generated as output. In some such examples, the threat analysis data includes data that classifies events and/or entities associated with the input data as likely or possible threats. Alternatively, or additionally, the threat analysis data includes data that indicates a degree of likelihood that a data entry from the input data is associated with a likely or possible threat.

In some examples, the threat analysis model 122 is a trained machine learning (ML) or artificial intelligence (AI) model. In some such examples, the threat analysis model 122 is trained using ML techniques to identify likely or possible threats based on previously known threats and patterns in the input data. For instance, the threat analysis model 122 is provided a set of enriched data 114. The threat analysis model 122 performs data analysis per its training and classifies data patterns in the enriched data 114 as types of possible threats and/or generates scores indicating the likelihood that the data patterns represent possible threats. Such analysis can be performed for each enriched data 114 entry, such that possible threats throughout the set of enriched data 114 are determined. In other examples, other ML methods of likely or possible threats in enriched data 114 and/or synthetic data 120 are used by the threat analysis model 122 without departing from the description.

Additionally, or alternatively, in some examples, the threat analysis model 122 is trained using ML principles or techniques. In some such examples, a set of training data includes data from a set of enriched data 114 and, for the data in the training data set, represented threats therein are known. The threat analysis model 122 is initialized to generate classifications of enriched data entries as associated with types of threats. Portions of the training data set are provided as input to the threat analysis model 122 and the threat analysis model 122 generates classifications for entries in the input enriched data 114. The generated classifications are compared to the known classifications of the training data set. An accuracy of the generated classifications is determined based on the generated classifications matching the known classifications for entries of the training data set. Generated classifications that do not match the known classifications of the training data set are also used in determining the accuracy of the threat analysis model 122. Based on the determined accuracy, parameters, weights, and/or other elements of the threat analysis model 122 are adjusted according to ML techniques, such that the accuracy of the threat analysis model 122 is improved for the purpose of generating classifications for input data that is similar to the training data. In other examples, other methods of training the threat analysis model 122 are used without departing from the description.

In some examples, the threat analysis model 122 generates threat analysis output data that includes threatscape analysis data 124, potential security trend data 126, and/or anticipated resiliency trend data 128. In some such examples, the threatscape analysis data 124 indicates and/or predicts future security threats to the systems with which the private data sources and/or public data sources are associated, including future security threats that are likely to arise along a relatively long timeline, such as likely security threats that will arise in five years, ten years, or more. Further, the generation of threatscape analysis data 124 and/or other threat analysis output data as described herein includes analyzing historical data over such time periods and identifying patterns in those historical data that are indicative of the appearance of major security threats at later times.

In some such examples, the threatscape analysis data 124 includes data indicative of “gates” associated with future security threats, wherein the gates are events and/or data patterns that are likely to lead to the future security threats. In such examples, the threat analysis model 122 is trained using data that is representative of gate events that have occurred in the past and associated data patterns that indicate the rise of security threats that are caused by, enabled by, or otherwise associated with those gate events. Thus, the threat analysis model 122 is configured and trained to identify future gate events and/or to provide some information about future threats that may be associated with those identified gate events. In some such examples, the threat analysis model 122 even predicts threats based on likely future technology that does not exist or is otherwise not in use.

Additionally, or alternatively, the threat analysis output data includes the potential security trend data 126. In some examples, the potential security trend data 126 indicates likely future trends in security operations for systems or entities associated with the private data sources and/or the public data sources. In some such examples, the potential security trend data 126 includes indications of likely changes in the use of security tools or likelihood that particular security tools become more or less useful or important, likely changes in security operations or tasks that are required for maintaining a specific level of security or the like.

Further, in some examples, the threat analysis output data includes anticipated resiliency trend data 128. In such examples, the anticipated resiliency trend data 128 indicates the resiliency of systems and associated infrastructure in response to disasters or other events that have a negative impact on those systems. For instance, in an example, the anticipated resiliency trend data 128 includes data that predicts the performance of specific systems or portions of infrastructure in response to power loss events, network connectivity events, Distributed Denial of Service (DDOS) events, ransomware events, or the like. Additionally, or alternatively, in some such examples, the anticipated resiliency trend data 128 includes data indicating the likelihood or other ratings of different types of negative impact events and the trends in system and/or infrastructure resilience are provided in the context of those different types of negative impact events. Thus, the anticipated resiliency trend data 128 can provide information about which possible events are most likely and/or which possible events require the most preparation efforts to improve resiliency of the systems and/or infrastructure.

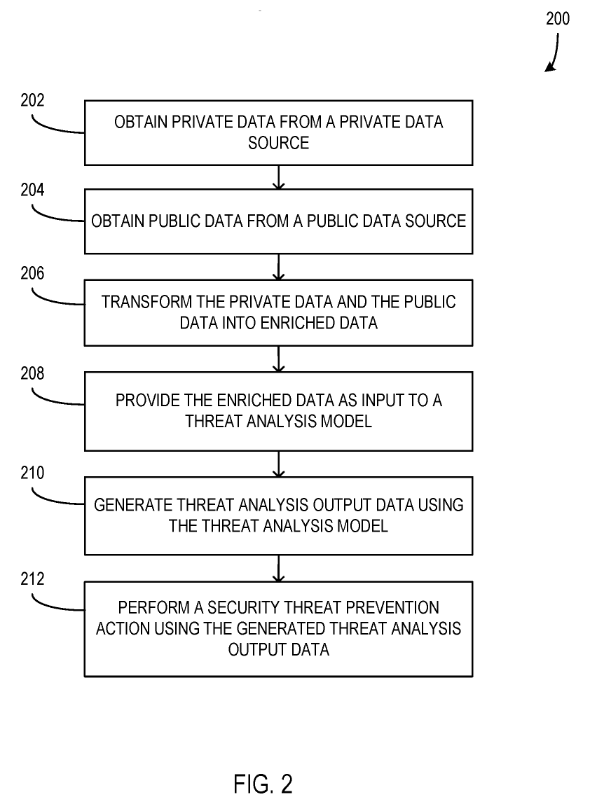

FIG. 2 is a flowchart illustrating a method 200 of generating threat analysis output data based on a combination of private data and public data and performing a security threat prevention action based on the threat analysis output data. In some examples, the method 200 is executed or otherwise performed by or in association with a system such as system 100 of FIG. 1.

At 202, private data 108 is obtained from a private data source 104. In some examples, the private data includes network traffic data, file hash data, firewall data, transaction data, payment data, account behavior data, data associated with past security threat events, merchant fraud event data, user behavior data, or the like.

At 204, public data 110 is obtained from a public data source 106.

At 206, the private data 108 and the public data 110 are transformed into enriched data 114. In some examples, transforming the private data 108 and public data 110 into enriched data 114 includes identifying a private data portion of the private data and determining a public data portion of the public data that is likely to be associated with an entity with which the identified private data portion is associated. Then, an enriched data artifact associated with the entity is generated, including the data of the identified private data portion and of the determined public data portion.

At 208, the enriched data 114 is provided as input to the threat analysis model 122. Additionally, or alternatively, in some examples, synthetic data 120 is generated from sensitive data 116 of the private data 108 and provided as input to the threat analysis model 122 as described herein. For instance, in an example, sensitive data 116 is identified and statistical patterns of the sensitive data 116 are determined. The synthetic data 120 is generated using the determined statistical patterns, such that the synthetic data 120 includes the determined statistical patterns but lacks sensitive details of the sensitive data 116.

At 210, threat analysis output data (e.g., threatscape analysis data 124, potential security trend data 126, and/or anticipated resiliency trend data 128) is generated using the threat analysis model 122.

At 212, a security threat prevention action is performed using the generated threat analysis output data. In some examples, the security threat prevention action includes generating a multi-year threat plan associated with predicted security threats during a time span (e.g., two years, five years, or more). Further, in some such examples, the method includes enacting, implementing, or otherwise performing actions associated with the multi-year threat plan. Alternatively, or additionally, the security threat prevention action includes generating notifications and/or reports that describe predicted threats, gates that lead to predicted threats, and/or specific threat campaigns that are ongoing or imminent. Further, in some examples, the security threat prevention action includes automatic adjustment of security rules and/or settings of a system based on the threat analysis output data. For instance, the threat analysis output data identifies a predicted security trend and, in response to that predicted security trend, a security setting of the system is changed to address the predicted security trend.

In some examples, the security threat prevention action includes generating a threat “road map” associated with predicted security threats over a relatively long time span, such as ten years. Predicted threats and gates associated therewith are included in the road map. As predicted gates occur over time, the road map is adjusted to account for the occurrence of those gates.

Further, in some examples, the security threat prevention action includes the identification of a plurality of security actions to take. The method prioritizes the plurality of security actions or otherwise determines which actions to do urgently and which actions to perform at a later time. Long-term security actions are prioritized over a multi-year time span (e.g., five years).

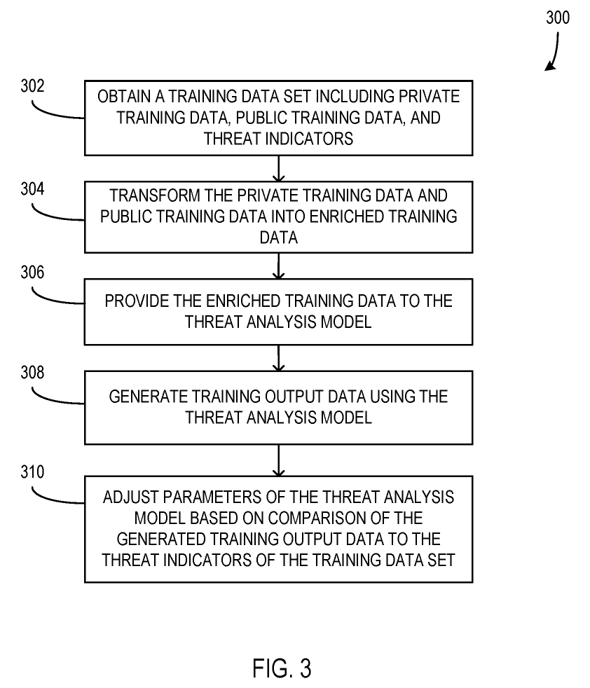

FIG. 3 is a flowchart illustrating a method 300 of training a threat analysis model. In some examples, the method 300 is executed or otherwise performed by or in association with a system such as system 100 of FIG. 1.

At 302, a training data set is obtained, wherein the training data set includes private training data (e.g., private data 108), public training data (e.g., public data 110), and threat indicators. In some examples, the threat indicators are associated with data patterns in the private training data and the public training data and with known security threats associated with those data patterns.

At 304, the private training data and the public training data are transformed into enriched training data (e.g., enriched data 114). In some examples, the transformation of data into enriched data is performed in the same way as described above with respect to FIG. 1.

At 306, the enriched training data is provided to the threat analysis model 122 and, at 308, training output data (e.g., threatscape analysis data 124, potential security trend data 126, and/or anticipated resiliency trend data 128) is generated using the threat analysis model 122.

At 310, parameters of the threat analysis model 122 are adjusted based on comparison of the generated training output data to the threat indicators of the training data set. It should be understood that the parameters and/or other features of the threat analysis model 122 are adjusted using one or more machine learning techniques without departing from the description.

Conventional ML threat models trained solely on isolated public or private datasets typically exhibit reduced accuracy in forecasting low-frequency, high-impact security events. Without enriched data, many subtle precursors—such as cross-domain correlations between IP address patterns in private logs and public vulnerability disclosures—remain undetected. Similarly, without synthetic replicas of sensitive data patterns, retraining such models often requires direct access to restricted datasets, introducing delays and limiting update frequency. The combined enrichment and synthetic data generation processes disclosed herein overcome these limitations, enabling the threat analysis model to detect complex, emergent threat patterns months or even years before conventional models could produce a reliable prediction.

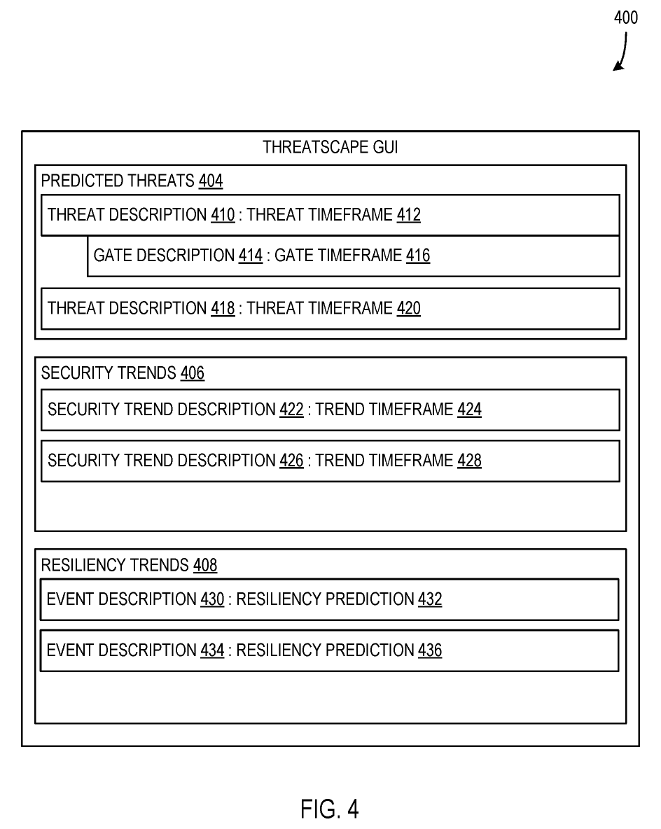

FIG. 4 is a diagram illustrating a threatscape graphical user interface (GUI) 400 configured to display and/or enable interaction with threat analysis output data (e.g., output data generated by the threat analysis model 122). In some examples, the threatscape GUI 400 is executed, displayed, or otherwise presented by or in association with a system such as system 100 of FIG. 1. Further, in some examples, the threatscape GUI 400 is executed, displayed, or otherwise presented during the performance of a method such as method 200 of FIG. 2.

The threatscape GUI 400 includes a predicted threats section 404. In some examples, the predicted threats section 404 displays or presents threat descriptions and associated threat timeframes, such as threat descriptions 410 and 418 and corresponding threat timeframes 412 and 420. Threat descriptions 410 and 418 present information that describes predicted threats, such as terms that name the threats, information about possible causes of the threats, and/or any other descriptive information. Threat timeframes 412 and 420 indicate the likely timeframes during which the threats are most likely to occur (e.g., a timeframe starting in one year and ending in 4 years). Additionally, or alternatively, threat timeframes 412 and 420 include information about how the likelihood of threats change over the course of the timeframes (e.g., a curve is displayed that indicates increasing and/or decreasing probability of a threat over the timeframe).

Additionally, in some examples, the predicted threats section 404 includes gate descriptions and associated gate timeframes, such as gate description 414 and gate timeframe 416. In some such examples, gates that are predicted with respect to threats are displayed or presented in association with the associated threat descriptions. As illustrated, the gate described by the gate description 414 is associated with the threat description 410. The gate description 414 includes information that identifies the gate, describes likely causes and/or effects of the gate, and provides other descriptive information about the gate. The associated gate timeframe 416 indicates likely timeframes during which the gate is most likely to occur. It should be understood that gate timeframes 416 and threat timeframes 412 and 420 include similar information about the respective gates and threats and/or different information that is specific to gates and/or threats without departing from the description. In other examples, more, fewer, or different types of information are provided by the predicted threats section 404 without departing from the description.

The threatscape GUI 400 includes a security trends section 406 that is configured to display or present security trend descriptions (e.g., security trend descriptions 422 and 426) and associated trend timeframes (e.g., trend timeframes 424 and 428). Security trend descriptions include information that identifies security trends, information that describes likely cause and/or effects of those security trends, recommended actions to take in response to the security trends, and/or other descriptive information. Trend timeframes indicate likely timeframes during which the security trends are likely to occur or otherwise become common or popular. In other examples, more, fewer, or different types of information are provided by the security trends section 406 without departing from the description.

The threatscape GUI 400 includes a resiliency trends section 408 that is configured to display event descriptions (e.g., event descriptions 430 and 434) and associated resiliency predictions (e.g., resiliency predictions 432 and 436). Event descriptions include information that identifies the predicted events, describes likely causes and/or effects of the predicted events, and/or other descriptive information. Resiliency predictions include information describing predicted actions to be taken in response to associated events, information indicating likelihood that associated systems are resilient to the associated events, and/or likely costs and/or effects of actions taken in response to the events to improve resiliency of systems. In other examples, more, fewer, or different types of information are provided by the resiliency trends section 408 without departing from the description.

In some examples, the threatscape GUI 400 includes or is in communication with an interface configured to accessing threatscape analysis data 124, potential security trend data 126, and/or anticipated resiliency trend data 128 as generated by the threat analysis model 122 and stored in an associated data store. The threatscape GUI 400 and interface accesses the data store periodically and/or in response to notifications or events. In some such examples, the threatscape GUI 400 determines that threatscape analysis data 124 stored in the data store has been updated since a previous accessing and, in response to this determination, the threatscape GUI 400 obtains the updated threatscape analysis data 124. The threatscape GUI 400 uses the updated threatscape analysis data 124 to alter, amend, or update the predicted threats section 404 to display or present threat descriptions, gate descriptions, threat timeframes, and/or gate timeframes based on the updated threatscape analysis data 124. In some examples, altering, amending, and/or updating the threatscape GUI 400 includes moving GUI components (e.g., threat description entries) between locations, reordering GUI components based on newly added components, activating or highlighting of GUI components based on the newly added components or the like. For instance, in an example, a predicted gate of gate description 414 is determined to have occurred based on updated threat analysis data 124. In response to the determination, the threat timeframe 412 of the threat description 410 is updated based on the occurrence of the associated gate and the gate description 414 entry is highlighted to indicate that the associated gate has been detected. In other examples, other methods of updating the threatscape GUI 400 are used without departing from the description. Further, it should be understood that, in some examples, the security trends section 406 (e.g., based on potential security trend data 126) and/or resiliency trends section 408 (e.g., based on anticipated resiliency trend data 128) are updated in the same manner as described above for the predicted threats section 404 without departing from the description.

For instance, in one scenario, private data sources 104 provide transaction metadata from a financial institution, including timing and amount information for high-value transfers, while public data sources 106 provide breach disclosure announcements and malware campaign reports. The enrichment process identifies that a cluster of unusual transaction timings aligns with activity from entities named in public breach disclosures. Synthetic data generated from the private transaction patterns enables the threat analysis model to train on these correlations without revealing customer identities. As a result, the model produces a high-confidence forecast that a ransomware campaign targeting the institution’s supply-chain partners is likely to launch within the next six months. This forecast allows the institution to adjust its security controls and supplier vetting processes in advance, preventing a class of attacks that would otherwise not be detected until active compromise.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, generating threat analysis data using a combination of private and public data as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain private data from a private data source; obtain public data from a public data source; transform the private data and the public data into enriched data; provide the enriched data as input to a threat analysis model; generate threat analysis output data using the threat analysis model; and perform a security threat prevention action using the generated threat analysis output data.

An example computerized method comprises obtaining private data from a private data source; obtaining public data from a public data source; transforming the private data and the public data into enriched data; generating synthetic data from sensitive data in the private data, wherein the synthetic data includes preserved statistical patterns of the sensitive data and omits sensitive identifiers; providing the enriched data and the synthetic data as input to a threat analysis model; generating threat analysis output data using the threat analysis model; and performing a security threat prevention action using the generated threat analysis output data.

One or more computer storage media having computer-executable instructions that, upon execution by a processor, case the processor to at least: obtain private data from a private data source; obtain public data from a public data source; transform the private data and the public data into enriched data artifacts, each enriched data artifact associating data portions determined to relate to a same entity or event; provide the enriched data artifacts as input to a threat analysis model; generate threat analysis output data using the threat analysis model; present, in a graphical user interface (GUI), a visualization of the threat analysis output data including at least one of a predicted threat, a predicted gate event associated with the predicted threat, and an anticipated resiliency prediction; and perform a security threat prevention action using the generated threat analysis output data.

Alternatively, or in addition to the other examples described herein, examples include any combination of the following:

-wherein performing the security threat prevention action includes generating a multi-year threat plan associated with predicted threats during a time span of at least two years from a current time.

-wherein transforming the private data and the public data into the enriched data includes: identifying a private data portion of the private data; determining a public data portion of the public data that is likely to be associated with an entity with which the identified private data portion is associated; and generating an enriched data artifact associated with the entity and including data of the identified private data portion and data of the determined public data portion.

-further comprising: identifying sensitive data in the private data; determining a statistical pattern of the identified sensitive data; generating synthetic data using the determined statistical pattern, wherein the generated synthetic data includes the determined statistical pattern and lacks sensitive details of the identified sensitive data; and providing the generated synthetic data as input to the threat analysis model, whereby the generated threat analysis output data is based at least in part on the generated synthetic data.

-further comprising training the threat analysis model, the training comprising: obtaining a training data set including private training data, public training data, and a threat indicator associated with a data pattern in the private training data and the public training data; transforming the private training data and the public training data into enriched training data; providing the enriched training data to the threat analysis model; generating training output data using the threat analysis model; and adjusting a parameter of the threat analysis model based on a comparison of the generated training output data to the threat indicator of the training data set.

-wherein the private data includes at least one of the following: network traffic data, file hash data, firewall data, transaction data, payment data, account behavior data, data associated with past security threat events, merchant fraud event data, or user behavior data.

-wherein the threat analysis output data includes at least one of threatscape analysis data, potential security trend data, or anticipated resiliency trend data.

-wherein generating the threat analysis output data using the threat analysis model includes: identifying a predicted gate event that is determined to be a precursor to a predicted security threat; generating a description of the predicted gate event including a likely timeframe during which the gate event is predicted to occur; and providing the description of the predicted gate event in association with the predicted security threat as part of the threat analysis output data.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining private data from a private data source; exemplary means for obtaining public data from a public data source; exemplary means for transforming the private data and the public data into enriched data; exemplary means for providing the enriched data as input to a threat analysis model; exemplary means for generating threat analysis output data using the threat analysis model; and exemplary means for performing a security threat prevention action using the generated threat analysis output data.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain private data from a private data source;
obtain public data from a public data source;
transform the private data and the public data into enriched data;
provide the enriched data as input to a threat analysis model;
generate threat analysis output data using the threat analysis model; and
perform a security threat prevention action using the generated threat analysis output data.

2. The system of claim 1, wherein performing the security threat prevention action includes generating a multi-year threat plan associated with predicted threats during a time span of at least two years from a current time.

3. The system of claim 1, wherein transforming the private data and the public data into the enriched data includes:
identifying a private data portion of the private data;
determining a public data portion of the public data that is likely to be associated with an entity with which the identified private data portion is associated; and
generating an enriched data artifact associated with the entity and including data of the identified private data portion and data of the determined public data portion.

4. The system of claim 1, wherein the memory and the computer program code are further configured to cause the processor to:
identify sensitive data in the private data;
determine a statistical pattern of the identified sensitive data;
generate synthetic data using the determined statistical pattern, wherein the generated synthetic data includes the determined statistical pattern and lacks sensitive details of the identified sensitive data; and
provide the generated synthetic data as input to the threat analysis model, whereby the generated threat analysis output data is based at least in part on the generated synthetic data.

5. The system of claim 1, wherein the memory and the computer program code are further configured to cause the processor to train the threat analysis model, the training comprising:
obtaining a training data set including private training data, public training data, and a threat indicator associated with a data pattern in the private training data and the public training data;
transforming the private training data and the public training data into enriched training data;
providing the enriched training data to the threat analysis model;
generating training output data using the threat analysis model; and
adjusting a parameter of the threat analysis model based on a comparison of the generated training output data to the threat indicator of the training data set.

6. The system of claim 1, wherein the private data includes at least one of the following: network traffic data, file hash data, firewall data, transaction data, payment data, account behavior data, data associated with past security threat events, merchant fraud event data, or user behavior data.

7. The system of claim 1, wherein the threat analysis output data includes at least one of threatscape analysis data, potential security trend data, or anticipated resiliency trend data.

8. A computerized method comprising:
obtaining private data from a private data source;
obtaining public data from a public data source;
transforming the private data and the public data into enriched data;
generating synthetic data from sensitive data in the private data, wherein the synthetic data includes preserved statistical patterns of the sensitive data and omits sensitive identifiers;
providing the enriched data and the synthetic data as input to a threat analysis model;
generating threat analysis output data using the threat analysis model; and
performing a security threat prevention action using the generated threat analysis output data.

9. The computerized method of claim 8, wherein performing the security threat prevention action includes generating a multi-year threat plan associated with predicted threats during a time span of at least two years from a current time.

10. The computerized method of claim 8, wherein transforming the private data and the public data into the enriched data includes:
identifying a private data portion of the private data;
determining a public data portion of the public data that is likely to be associated with an entity with which the identified private data portion is associated; and
generating an enriched data artifact associated with the entity and including data of the identified private data portion and data of the determined public data portion.

11. The computerized method of claim 8, wherein generating the threat analysis output data using the threat analysis model includes:
identifying a predicted gate event that is determined to be a precursor to a predicted security threat;
generating a description of the predicted gate event including a likely timeframe during which the gate event is predicted to occur; and
providing the description of the predicted gate event in association with the predicted security threat as part of the threat analysis output data.

12. The computerized method of claim 8, further comprising training the threat analysis model, the training comprising:
obtaining a training data set including private training data, public training data, and a threat indicator associated with a data pattern in the private training data and the public training data;
transforming the private training data and the public training data into enriched training data;
providing the enriched training data to the threat analysis model;
generating training output data using the threat analysis model; and
adjusting a parameter of the threat analysis model based on a comparison of the generated training output data to the threat indicator of the training data set.

13. The computerized method of claim 8, wherein the private data includes at least one of the following: network traffic data, file hash data, firewall data, transaction data, payment data, account behavior data, data associated with past security threat events, merchant fraud event data, or user behavior data.

14. The computerized method of claim 8, wherein the threat analysis output data includes at least one of threatscape analysis data, potential security trend data, or anticipated resiliency trend data.

15. A computer storage medium has computer-executable instructions that, upon execution by a processor, cause the processor to at least:
obtain private data from a private data source;
obtain public data from a public data source;
transform the private data and the public data into enriched data artifacts, each enriched data artifact associating data portions determined to relate to a same entity or event;
provide the enriched data artifacts as input to a threat analysis model;
generate threat analysis output data using the threat analysis model;
present, in a graphical user interface (GUI), a visualization of the threat analysis output data including at least one of a predicted threat, a predicted gate event associated with the predicted threat, and an anticipated resiliency prediction; and
perform a security threat prevention action using the generated threat analysis output data.

16. The computer storage medium of claim 15, wherein performing the security threat prevention action includes generating a multi-year threat plan associated with predicted threats during a time span of at least two years from a current time.

17. The computer storage medium of claim 15, wherein transforming the private data and the public data into the enriched data includes:
identifying a private data portion of the private data;
determining a public data portion of the public data that is likely to be associated with an entity with which the identified private data portion is associated; and
generating an enriched data artifact associated with the entity and including data of the identified private data portion and data of the determined public data portion.

18. The computer storage medium of claim 15, wherein the computer-executable instructions, upon execution by the processor, further causes the processor to at least:
identify sensitive data in the private data;
determine a statistical pattern of the identified sensitive data;
generate synthetic data using the determined statistical pattern, wherein the generated synthetic data includes the determined statistical pattern and lacks sensitive details of the identified sensitive data; and
provide the generated synthetic data as input to the threat analysis model, whereby the generated threat analysis output data is based at least in part on the generated synthetic data.

19. The computer storage medium of claim 15, wherein the computer-executable instructions, upon execution by the processor, further causes the processor to at least train the threat analysis model, the training comprising:
obtaining a training data set including private training data, public training data, and a threat indicator associated with a data pattern in the private training data and the public training data;
transforming the private training data and the public training data into enriched training data;
providing the enriched training data to the threat analysis model;
generating training output data using the threat analysis model; and
adjusting a parameter of the threat analysis model based on a comparison of the generated training output data to the threat indicator of the training data set.

20. The computer storage medium of claim 15, wherein the private data includes at least one of the following: network traffic data, file hash data, firewall data, transaction data, payment data, account behavior data, data associated with past security threat events, merchant fraud event data, or user behavior data.
